(19) United States
(12) Patent Application Publication
(10) Pub. No.: US 2004/0096292 A1
(43) Pub. Date: May 20, 2004

(54) Panel fastener with retaining ring

(75) Inventors: John A. Duran, Glendora, CA (US); Edward Avetisian, Burbank, CA (US); Peter Chang, Burbank, CA (US); Claudio Varela, Palmdale, CA (US)

Correspondence Address: GREENBERG TRAURIG LLP, 2450 COLORADO AVENUE, SUITE 400E, SANTA MONICA, CA, 90404, US

(73) Assignee: AVIBANK MFG., INC.

(21) Appl. No.: 10/295,211

(22) Filed: Nov. 14, 2002

(51) Int. Cl. F16B 21/18

(52) U.S. Cl. 411/352

(57) ABSTRACT

A fastener assembly having a bolt having a shaft with a plurality of spaced elongated closed end splines spaced from a like plurality of open ended splines. Each pair of splines are interconnected by a crossover slot of the same or greater depth than the closed end and open ended splines. The entry into the crossover slots is wide enough for ears of a retaining ring that is inserted onto the open ended splines of the bolt shaft to pass through the crossover slots and be forced out of a restricted width exit leading from the crossover slot to the closed end spline thereby trapping the ring on the bolt shaft with the ears reciprocating in the closed end splines.

### BACKGROUND OF THE INVENTION

The invention relates to panel fasteners; and, more particularly, to a captive panel fastener having a retaining ring with tangs received in closed end splines on the shaft of a bolt.

### RELATED ART

Captive panel fasteners are well known in the aircraft art. For example, in U.S. Pat. No. 3,995,675 to Cosenza, there is described a captive panel fastener assembly wherein a retaining ring with inwardly extending tabs slidably ride along the body of a stud, the tabs entering splines extending lengthwise of the stud. A knurled plug is press-fit into a bore at the nose of the stud after insertion of the stud through a hole in a panel and after placement of the ring on the stud. This retains the ring to the stud and allows a more rigid and closely fitting retaining ring to be used as a captivating means of the stud to the panel. The retaining ring is more resistant to accidental displacement than more flexible retaining rings.

However, in my U.S. Pat. No. 4,828,442, I disclosed an improved captive panel fastener assembly having an integral hold out spring and built-in stop ring provided on a threaded bolt. The bolt is adapted to be inserted through a hole in a panel. The hold out spring and built-in stop ring are inserted into a bore in the bolt, the hold out spring portion extending out of a slot in the bolt and the built-in stop ring portion entering a groove adjacent the nose of the bolt. In one embodiment of the invention, a washer having inwardly extending tabs is installed on the shank of the bolt prior to insertion of the built-in stop ring portion, the tabs riding in grooves extending along the outer body of the bolt and stopped in their downward movement by engagement with the built-in stop ring portion.

In my U.S. Pat. No. 5,399,053, I disclose a fastener assembly for joining a panel to a sub-panel comprising a receptacle assembly having a threaded stud secured to the undersurface of the sub-panel. The assembly includes a bolt having an enlarged head at one end and a nose at the other end. The panel has a countersunk opening aligned with an opening in the sub-panel. The bolt is threaded for threaded engagement to the stud. The body of the bolt includes a plurality of spaced grooves extending longitudinally along the outer surface of the bolt body. A retainer surrounds the bolt body having spaced ears riding in the grooves and a stop in a groove adjacent the nose of the bolt stops the downward movement of the retainer. A cup member surrounds the retainer thereby protecting the retainer during its movement along the grooves. A similar arrangement is disclosed in my U.S. Pat. No. 4,948,316. All of my foregoing patents require a stop on the shaft of the bolt to prevent the retainer from exiting off of the bolt shaft.

In U.S. Pat. No. 4,911,726 to Warkentin, there is disclosed an elongated fastener engagable with a retaining ring to secure the fastener to a panel. The fastener includes a first set of uniformly-spaced splines extending along its external surface and terminating at an end of the fastener opposite an enlarged head. A second set of longitudinal splines is interleaved with the first set, these second splines being closed at their opposite ends. A separate crossover slot connects together each associated pair of open-end and closed-end splines. A retainer ring having inwardly-projecting tabs is slid onto the fastener with its tabs engaging the first set of open-end splines and the retaining ring is thereafter rotated to slide the tabs across the crossover slots to the closed-end splines. The depth of the crossover slots is less than the depth of the closed-end splines, such that the retaining ring must expand or flex outwardly when the tabs are slid across the slots. A special insertion tool used to secure the retaining ring in place has a general cylindrical shape and an opening in one end for receiving the fastener. The end of the tool is notched to engage the retaining ring tabs, and the tool wall is sufficiently thin to fit between the fastener and the retaining ring.

Although this patent eliminates the need for a stop on the shaft of the bolt, a special insertion tool is needed to secure the retaining ring in place.

There is a need for a panel fastener having a retaining ring adapted to be slidably mounted thereon without the ring exiting off of the shaft of the bolt so as to hold the fastener to a panel or the like. Such a fastener should not require a special tool to assemble the ring to the fastener nor require careful machining of the depth of the crossover slots in the bolt body.

### SUMMARY OF THE INVENTION

It is an object of this invention to provide a fastener retaining ring assembly adapted to be secured to an aircraft panel or the like without need for special assembly tools.

It is a further object of this invention to provide such an assembly having a bolt with crossover slots for receiving tangs of the retaining ring therein which slots do not require careful machining of the depths thereof.

These and other objects are preferably accomplished by a fastener assembly having a bolt having a shaft with a plurality of spaced elongated closed end splines spaced from a like plurality of open ended splines. Each pair of splines is interconnected by a crossover slot of the same or greater depth than the closed end splines and open ended splines. The entry into the crossover slots from the opened ended splines is wide enough for ears of a retaining ring that is inserted onto the open ended splines of the bolt shaft to pass through the crossover slots and be forced out of a restricted width exit leading from the crossover slot to elongated closed end splines. Each pair of closed and open ended splines is interconnected by a crossover slot of the same or greater depth than the closed end splines and open ended splines. The ring is thus trapped on the bolt shaft with the ears riding in the closed end splines.

The retaining ring cannot back out of the closed end splines as the ears must be forced through the crossover slots into the open ended splines.

### BRIEF DESCRIPTION OF THE DRAWINGS

FIG. 1 is an elevational perspective view of a bolt in accordance with the teachings of the invention;

FIG. 2 is an illustrative view of the slot and spline configuration on the bolt of FIG. 1 shown in flat planar form for purposes of illustration only;

FIG. 3 is a perspective view of the bolt of FIG. 1 and a retainer ring adapted to be mounted thereon;

FIG. 4 is a detailed view of a portion of the bolt of FIG. 1 illustrating dimensional relationships thereon;

FIG. 5 is a detailed view similar to FIG. 4;

FIG. 6 is a perspective view, partly in section, showing the bolt of FIGS. 1 to 5 mounted to a panel;

FIGS. 7 to 9 are detailed views of a portion of a bolt similar to the bolt of FIG. 1 showing modified crossover slots;

FIG. 10 is a vertical sectional view of the assembly of FIG. 6 installed to an abutting sub-panel;

FIG. 11 is an exploded view of a stud assembly prior to mounting to the sub-panel of FIG. 10; and

FIG. 12 is a view similar to FIG. 10 showing a modification of the shaft of FIGS. 1 to 11.

### DETAILED DESCRIPTION OF THE PREFERRED EMBODIMENTS

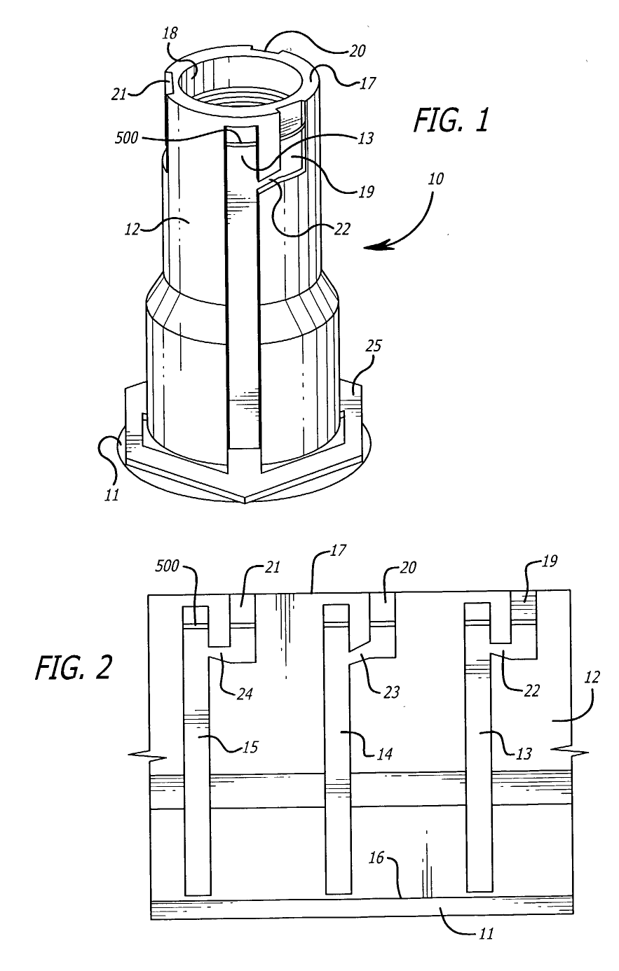

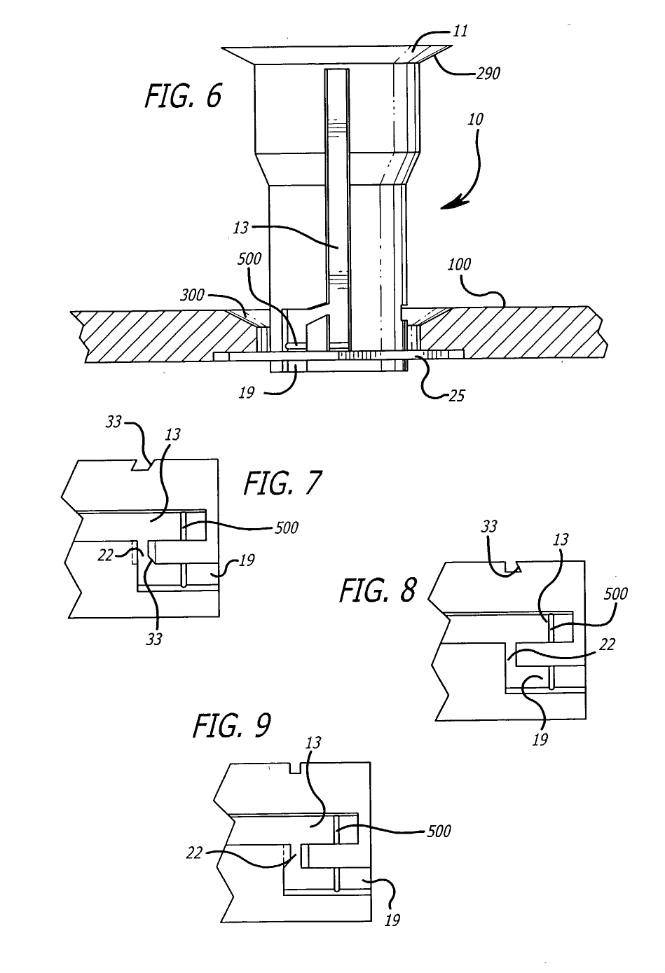

Referring now to FIG. 1 of the drawing, a first embodiment of a fastener retaining ring assembly is shown comprising a bolt 10 having an enlarged head 11 at one end and an elongated integral shaft 12. Three first elongated splines 13, 14, 15 (see also FIG. 2) are provided on shaft 12 each extending from the underside 290 (FIG. 6) of head 11 terminating at a point just before the terminal end 17 of shaft 12 (FIG. 1). Head 11 may be hex shaped for engagement by a suitable tool and shaft 12 may be hollow on its interior and threaded therein at threads 18 for engagement to a suitable threaded shaft, such as stud 15 (not shown) in my U.S. Pat. No. 5,399,053, the teachings of which are incorporated herein by reference.

Three open ended splines 19, 20, 21 extend part way along the periphery of shaft 12, spaced from their respective splines 13, 14, 15 and generally parallel thereto. As seen in FIGS. 1 and 2, each open ended splines 19, 20, 21 opens at nose or end 17 of shaft 12.

Three crossover slots 22, 23, 24 are associated with each spline 19, 20, 21 extending from its respective spline, such as slot 22 extending from spline 19 to spline 13, slot 23 extending from spline 20 to spline 14 and slot 24 extending from spline 21 to spline 15. As seen in FIGS. 1 and 2, each crossover slot 22, 23, 24 extends from its respective closed end spline at the point on shaft 12 where the closed end spline terminates. As will be discussed further hereinbelow, variations may be made in such slots and splines.

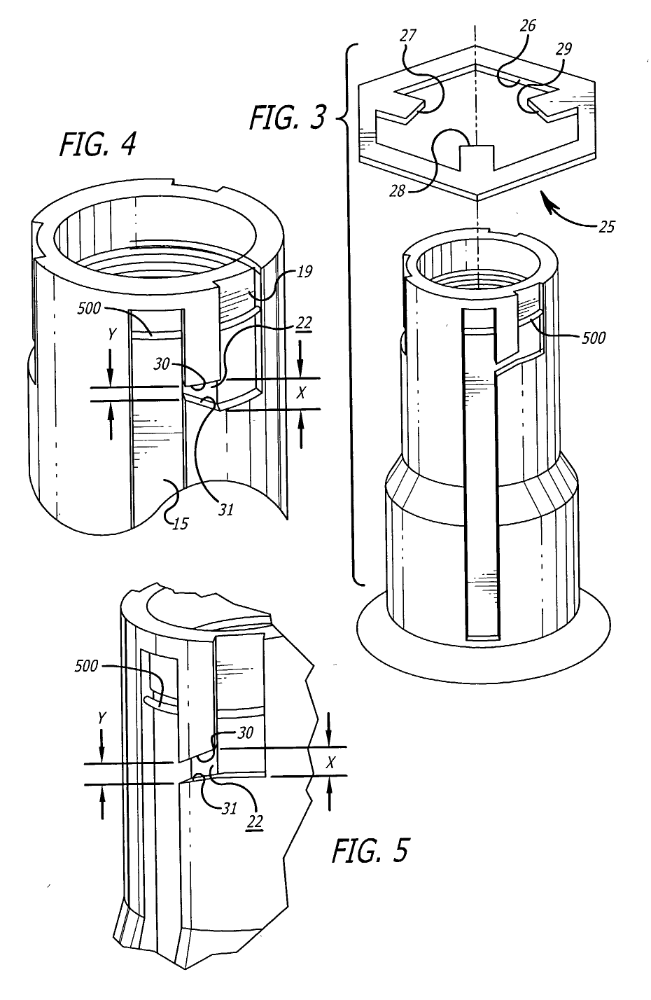

In any event, as seen in FIG. 3, a washer or ring 25 is provided having an inner hole 26 with indexing means in the form of a plurality of spaced inwardly extending ears 27 through 29 corresponding to open ended splines 19, 20, 21.

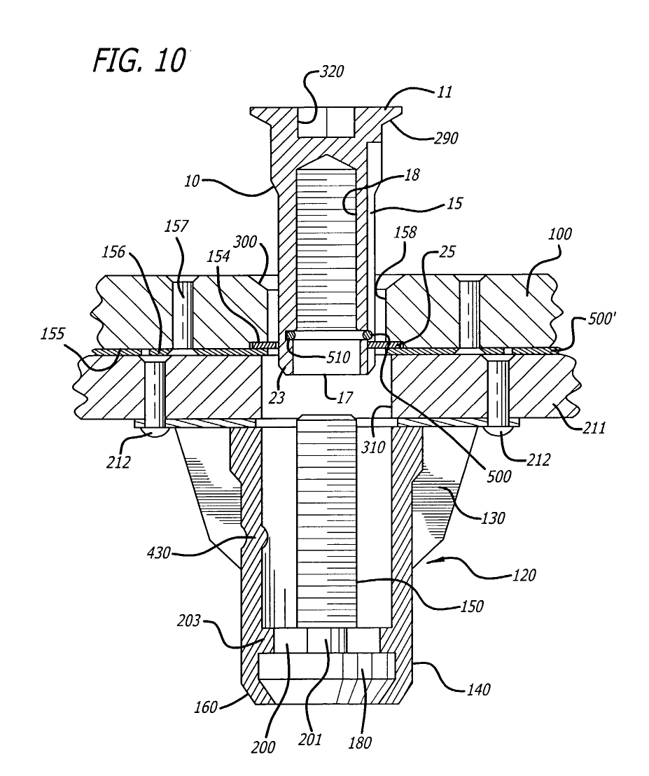

As will be discussed further hereinbelow, a circumferential groove 510 (see particularly FIG. 10) is machined internally of shaft 12 and a resilient ring 500 (FIG. 1) is mounted in groove 510 and thus extends in splines 13 to 15 and 19 to 21.

The depth of the crossover slots 22, 23, 24 is the same as or greater than the depth of the splines 13, 14,15 and 19, 20, 21. The entry, however, from the open ended spline 19 into its crossover slot 22 is wider than the exit out of slot 22 to the closed end spline 13 so that the tangs 27, 28, 29 of ring 25 must be flexed or forced into the crossover slot using a suitable tool. This is seen in FIG. 4 wherein the spacing x is wider than the spacing y. Also, one or both of the sidewalls 30, 31 forming slot 22 may be angled, as wall 31, to form the difference in spacing (see also FIG. 5).

Thus, once ring 25 is moved onto shaft 12 by the tangs thereof entering open ended splines 19, 20, 21, it is forced through the respective crossover slots 22, 23, 24 into closed end splines 13, 14,15. The ring 25 is thus trapped on shaft 12 and changes in orientation of the ring with respect to the fastener will not cause the ring to be released from engagement with the shaft 12 of the fastener 10. One example of use of a retaining ring, such as ring 25, with a grommet to hold the fastener to an aircraft panel is shown in U.S. Pat. No. 5,073,070. Another example of how the retaining ring is held in place to an aircraft panel is shown in my aforementioned U.S. Pat. Nos. 5,399,053 and 4,948,316. Finally, the fastener 10 and ring 25 may be merely secured to a panel, such as panel 100 as seen in FIG. 6.

Variations of the spacing x, y leading into and out of the crossover slots 22, 23, 24 may be provided. This is shown in FIGS. 7 and 9 wherein like numerals refer to like parts of the fastener of FIGS. 1 to 6. The entry into the crossover slot 22 from open ended spline 19 may be wider than the exit into the closed end spline 13 (FIG. 7) by angling one or both wall portions leading into slot 22. The angularity of wall portions 33, for example, can be seen clearly in FIGS. 7 and 8.

U.S. Pat. No. 5,399,053 discloses one means for holding the bolt of the fastener assembly out from the panel in which it is installed.

As seen in FIG. 10, bolt 10 is shown having a hex socket 320 and the tapered underside 290 of head 11 is adapted to enter and engage the countersunk opening 300 in panel 100. Like numerals refer to like parts of the bolt and panel of FIGS. 1 to 9.

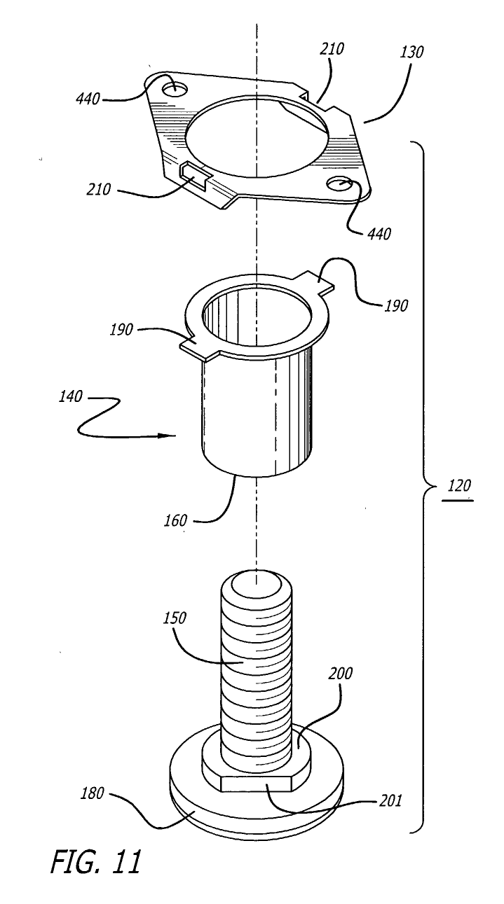

Receptacle assembly 120 is comprised of a receptacle bracket 130, a barrel 140 and an externally threaded stud 150. As seen in FIG. 10, the lower end 160 of barrel 140 is crimped about the base 180 of stud 150 to engage the stud 150 and connect the barrel 140 thereto. The stud 150 has a boss 200 with one or more flattened areas 201. Barrel 140 has an inwardly extending peripheral wall 203 configured similarly to boss 200. This is an anti-rotation feature preventing stud 150 from rotating within barrel 140 thereby allowing the stud 150 and barrel 140 to mate and lock and act as one unitary element. Barrel 140 also includes tabs or ears 190 (FIG. 11) which are inserted in a pair of slots 210, formed in basket 130, thereby connecting the barrel 140 to basket 130. Slots 210 are circumferentially greater in length than the width of tabs or ears 190 thereby permitting the barrel 140 and stud 150 to rotate to a limited degree with respect to basket 130. Basket 130 is secured to substructure or sub-panel 211 (FIG. 10) by any suitable means, such as rivets 212. Although receptacle assembly 120 and basket 130 have been described as an assembly of individual components, obviously a single element may be used.

If desired, a flat plate 156 (FIG. 10) may be riveted, via rivets 157, or otherwise secured to the underside 155 of panel 100. As seen in FIG. 10, plate 156 extends from hole 158 through panel 100 to a gasket 500′ provided between panel 100 and sub-panel 211. Thus, as seen in FIG. 10, retainer 25 is trapped between plate 156 and panel 100 in counterbore 154.

The holdout feature of this embodiment is described in detail in my U.S. Pat. No. 4,948,316.

The assembly of the elements of FIGS. 1 and 11 will now be described. After formation of openings 300 and 310 through panel 100 and sub-panel 211, respectively, the receptacle assembly 120 is secured to the underside of sub-panel 211 by riveting basket 130 to sub-panel 211 by rivets 212 passing through holes 440 (FIG. 11) in basket 130 and into sub-panel 211. The barrel 140 and stud 150 are secured thereto as heretofore described. One or more inwardly facing protrusions 430 (FIG. 10) may be provided on the exterior of barrel 140. These protrusions 430 provide a friction lock between the internal surface of barrel 140 and the exterior of bolt 10. Of course, any suitable thread lock as is known in the art may be used, such as a plastic insert installed through the side of barrel 140 or protrusions on the threads of the bolt.

Bolt 10 is now inserted through countersunk opening 300 and through hole 158 in panel 100. Ring 25 is mounted to bolt 11 with ears 27 to 29 entering slots 13 to 15 as heretofore discussed. Ring 25 moves over ring 500 and 25 cannot move off of bolt 10 because of its engagement with the closed ends of slots 13 to 15. Plate 156 is installed on panel 100. Thus, bolt 10 is trapped in opening 300 in panel 100 with ring 25 trapped between plate 156 and panel 100 in counterbore 154 and between ring 500 and the closed end of slots 13 to 15.

Sub-panel 211 may now be brought into position abutting against panel 100 and bolt 10 may be threaded to stud 150 on the receptacle assembly 120. Thus, sub-panel 211 is releasably secured to panel 100. The ring 25 rides in slots 13 to 15 up and down bolt 10 as heretofore described.

It can be seen that there is described a plurality of splines on a bolt shaft interconnected by cross over slots wherein a retaining ring can be slid into open ended splines on the bolt shaft and forced through the cross over slots into closed end splines. The ring can then move freely along the closed end splines thus providing a means for securing the bolt to a panel in a hold out position as heretofore described. The cross over slots have a restricted exit where opening into the closed end splines so that the retaining ring must be forced through the cross over slots into the closed end splines.

U.S. Pat. No. 5,399,053 discloses one means for holding the bolt of the fastener assembly out from the panel in which it is installed. In U.S. Pat. No. 5,399,053, this is provided by bumps 161 and ring 41. In U.S. Pat. No. 5,399,053 bumps 161 are machined into the slots where the washer normally rides when properly installed. This provides a stop for the tangs or ear of the washer so that when the tangs or ears engage these protrusions, the tangs or ears of the washer deflect as they pass over these protrusions thus creating a holdout feature. There is a ring at the end of the slot that stops the washer from coming off. As seen in FIG. 10 herein, during the manufacturing process, the groove 510 is machined into the shaft 12 and the ring 500 is mounted in groove 510. The ring 500 protrudes into the area of the splines 13 to 15 and 19 to 21. This provides a stop for the tangs or ears 27 to 29 of washer 25 so that when the tangs or ears 27 to 29 engage the ring 500, the ring 500 is compressed to allow the washer or ring 25 to pass over and rest at the end of the splines as seen in FIG. 6 thus providing a hold-out feature as shown in FIG. 10.

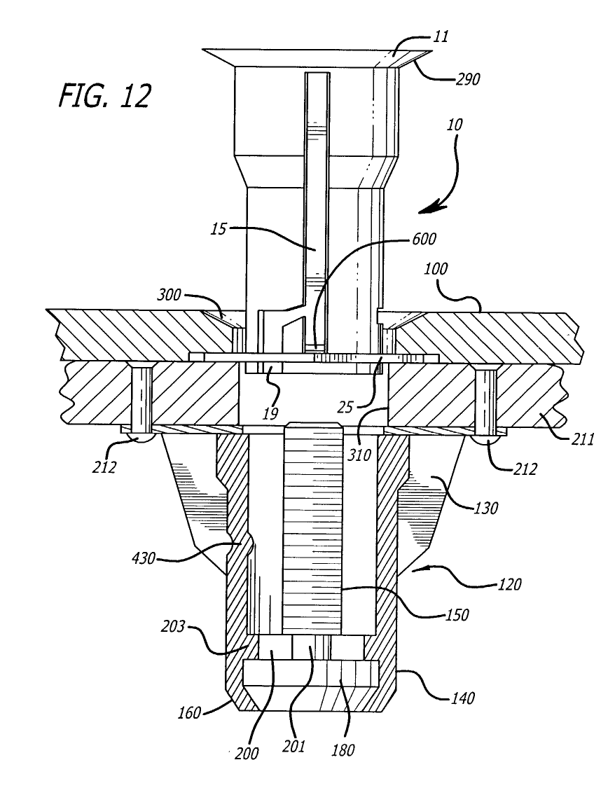

Alternatively, as shown in FIG. 12 wherein like numerals refer to like parts of FIG. 10, a bump 600, similar to bump 161 in my U.S. Pat. No. 5,399,053, may be machined in each spline 13 to 15 (only spline 15 visible in FIG. 12). These bumps 600 provide a stop for the tangs or ears 27 to 29 of ring or washer 25 so that, when tangs or ears 26 to 29 engage bumps 600, they deflect as they pass over the bumps 600 to FIG. 12 position, the downward movement of ring 25 being stopped by engagement with the closed ends of splines 13 to 15. Thus, the bolt 10 is in a hold out position with respect to the panel 100 as shown in FIG. 12.

While the specification describes particular embodiments of the present invention, those of ordinary skill can devise variations of the present invention without departing from the inventive concept.

We claim:

1. A bolt comprising:
an enlarged head at one end;
an elongated shaft integral with said head extending therefrom terminating at a terminal end remote from said head;
a plurality of elongated closed end splines extending along the exterior of said shaft from a first end at a point adjacent said head to a second end at a point before the terminal end of said shaft;
a plurality of open ended splines extending partway along the exterior of said shaft remote from said elongated closed end splines and generally parallel thereto, each of said open ended splines opening at the terminal end of said shaft and terminating on said shaft between the first and second ends of said elongated closed end splines; and
a plurality of crossover slots on said shaft, at least one of said crossover slots intersecting one of said elongated closed end splines and an adjacent one of said open end splines, the entrance into one of said crossover slots at said open ended spline having a spacing wider than the spacing at the exit of said one of said crossover slots where said one of said crossover slots opens into said closed end spline.

2. The bolt of claim 1 wherein said shaft is hollow and threaded on the interior thereof.

3. The bolt of claim 1 wherein said crossover slot extends at an angle from the horizontal between said closed end and open ended splines.

4. The bolt of claim 1 wherein the depth of said crossover slot is the same as the depth of said closed end and open ended splines.

5. The bolt of claim 1 wherein the depth of said crossover slot is greater than the depth of said closed end and open ended splines.

6. The bolt of claim 1 wherein said crossover slot is formed by a pair of spaced walls, at least one of said walls being angled inwardly and downwardly at said exit.

7. The bolt of claim 1 including a retaining ring mounted on said shaft having a plurality of inwardly extending tangs corresponding to the number of said elongated closed end splines, said tangs reciprocating in respective ones of said elongated closed end splines.

8. The bolt of claim 1 wherein three of said elongated closed end splines and three of said open end splines are provided, each of said respective pairs of said splines being interconnected by one of said crossover slots.

9. The bolt of claim 1 comprising a detent formed in each of said splines adjacent the terminal end of the shaft.

10. The bolt of claim 9 wherein said shaft has a body and each of said splines has a surface and said detent is a ring extending about the body of said shaft protruding from the surface of said splines outwardly therefrom.

11. In a fastener assembly for joining a panel to a sub-panel comprising a receptacle assembly having a threaded stud secured to the undersurface of the sub-panel, a bolt having an enlarged head at one end and a nose at the other end, said nose being adapted to extend through a countersink opening in said panel coaxially aligned with both of said openings, said bolt being threaded for threaded engagement to said stud, the improvement which comprises:
a retainer having indexing means extending inwardly toward the central longitudinal axis thereof;
said bolt having an enlarged head at one end;
an elongated shaft integral with said head extending therefrom terminating at a terminal end remote from said head;
a plurality of elongated closed end splines extending along the exterior of said shaft from a first end at a point adjacent said head to a second end at a point before the terminal end of said shaft;
a plurality of open ended splines extending partway along the exterior of said shaft remote from said closed end splines and generally parallel thereto, each of said open ended splines opening at the terminal end of said shaft and terminating on said shaft between the first and second ends of said closed end splines;
a plurality of crossover slots on said shaft, at least one of said crossover slots intersecting one of said elongated closed end splines and an adjacent one of said open end splines, the entrance into one of said crossover slots at said open ended spline having a spacing wider than the spacing at the exit of said one of said crossover slots where said one of said crossover slots opens into said elongated closed end spline;
said retainer mounted on said shaft with said indexing means disposed in selective ones of said closed end splines;
a plate secured to the underside of said panel trapping said retainer between the panel and said plate, said closed ends of said closed end splines providing restraining means for arresting the downward movement of said retainer and for stopping the upward movement of said retainer thereby retaining said bolt of said panel in an up or extracted position when said bolt is disengaged from said stud.

12. The assembly of claim 11 wherein said shaft is hollow and threaded on the interior thereof.

13. The assembly of claim 12 including a threaded stud fixed to said sub-panel adapted to threadably engage said shaft.

14. The assembly of claim 12 wherein said crossover slot extends at an angle from the horizontal between said closed end and open ended splines.

15. The assembly of claim 12 wherein the depth of said crossover slot is the same as the depth of said closed end and open ended splines.

16. The assembly of claim 12 wherein the depth of said crossover slot is greater than the depth of said closed end and open ended splines.

17. The assembly of claim 12 wherein said crossover slot is formed by a pair of spaced walls, at least one of said walls being angled inwardly and downwardly at said exit.

18. The assembly of claim 11 wherein said indexing means on said retainer comprises a plurality of inwardly extending tangs corresponding to the number of said closed end splines, said tangs reciprocating in respective ones of said closed end splines.

19. The assembly of claim 12 wherein three of said closed end splines and three of said open ended splines are provided, each of said closed end splines being interconnected by one of said crossover slots to a respective one of said open ended splines.

20. The bolt of claim 11 comprising a detent formed in each of said splines adjacent the terminal end of the shaft.

21. The bolt of claim 20 wherein said shaft has a body and each of said splines has a surface and said detent is a ring mounted in a groove extending about the body of said shaft protruding from the surface of said splines outwardly therefrom whereby said indexing means engages said ring compressing said ring inwardly as said indexing means moves along said splines thereby allowing said indexing means to move past said ring thereby holding said shaft in a holdout position between said ring and the closed ends of said closed end splines with respect to said plate.

22. The bolt of claim 11 comprising a detent disposed in said closed end splines adjacent the closed ends thereof.

23. The bolt of claim 22 wherein said detent is a bump protruding from the surface of at least one of said closed end splines into the path of said indexing means as said indexing means moves along said splines whereby said indexing means flexes and moves past said bump upon engagement with said bump thereby holding said bolt in a holdout position with respect to said plate when said retainer is disposed between said bump and the closed ends of said closed end splines.
